(19) United States
(12) Patent Application Publication
(10) Pub. No.: US 2025/0271694 A1
(43) Pub. Date: Aug. 28, 2025

(54) Display Panel and Display Device Including the Same

(71) Applicant: LG Display Co., Ltd., Seoul (KR)

(72) Inventors: Tae Kyung Kim, Paju-si (KR); Chel Hee Jo, Paju-si (KR); Yong Jun Yoo, Paju-si (KR)

(21) Appl. No.: 18/972,006

(22) Filed: Dec. 6, 2024

(30) Foreign Application Priority Data
Feb. 28, 2024 (KR) 10-2024-0029186

(51) Int. Cl. G02F 1/1333; G06F 3/041

(52) U.S. Cl. CPC G02F 1/13338; G06F 3/0412; G06F 3/04164

(57) ABSTRACT

Disclosed is a display panel including a substrate having a display area and a non-display area surrounding the display area, a plurality of gate lines and a plurality of data lines provided on the substrate, the gate lines and the data lines intersecting each other in the display area to define a plurality of pixel areas, a plurality of pixel electrodes provided respectively in the pixel areas, a plurality of common electrodes overlapping the pixel electrodes, the common electrodes being located on a different layer than the pixel electrodes, a plurality of touch lines connected respectively to the common electrodes, a plurality of data pad electrodes provided in the non-display area, the data pad electrodes being electrically connected to the data lines, and a plurality of touch pad electrodes provided in the non-display area, the touch pad electrodes being electrically connected to the touch lines.

### CROSS-REFERENCE TO RELATED APPLICATION

This application claims the benefit of Republic of Korea Patent Application No. 10-2024-0029186, filed on Feb. 28, 2024, which is hereby incorporated by reference in its entirety.

### FIELD OF TECHNOLOGY

The present disclosure relates to a display panel configured such that one electrode of the display panel is used as a touch line for touch sensing and a step with a chip or a film opposite to a pad electrode is prevented and a display device including the same.

### DISCUSSION OF THE RELATED ART

In recent years, display devices have been used not only alone, but also as display units in various electronic products.

Display devices include, for example, a liquid crystal display (LCD) device, an electroluminescent display (ELD) device, and an electrophoretic display (EPD) device. These display devices commonly include a display panel configured to display an image as an essential component, wherein the display panel includes an inherent luminescent material or has a structure in which a pair of insulating substrates is bonded to each other while facing each other in the state in which a material layer having optical anisotropy is disposed therebetween.

There is an increasing demand to add to the display device a touch panel capable of recognizing a touch region by a human hand or a separate input means and transmitting separate information in response thereto. The touch panel is attached to an outer surface of the display panel.

Recently, efforts have been made to realize an in-cell structure in which the touch panel is embedded in the display panel, recognizing the advantage of omission of a substrate addition and bonding process.

### SUMMARY

Embodiments of the present disclosure provide a display panel configured such that one of electrodes configured to form an electric field in a pixel area is used as an electrode for touch sensing.

Embodiments of the present disclosure provide a display panel configured such that a pad electrode includes three or more wiring layers, wherein connection holes between two adjacent wiring layers are disposed at different planar positions to reduce the step between the connection holes.

Embodiments of the present disclosure provide a display panel configured such that four or more wiring layer connection portions are provided in a part of a touch pad electrode, wherein at least one connection hole overlaps another connection hole, and at least one insulating film is provided in the area other than the overlapping area of the connection holes to reduce the step from the periphery thereof.

Embodiments of the present disclosure provide a display panel configured such that each of a data pad electrode and a touch pad electrode includes a first wiring layer provided on the same layer as a gate line, a second wiring layer provided on the same layer as a data line, a third wiring layer provided on the same layer as a pixel electrode or a common electrode, the first wiring layer, the second wiring layer, and the third wiring layer being stacked, and such that a first connection hole between the first wiring layer and the second wiring layer and a second connection hole between the second wiring layer and the third wiring layer overlap at least one insulating film, whereby the step between the connection holes is reduced, thereby preventing an indentation defect, a bending defect, and a light leakage defect due to the step and improving yield, and a display device including the same.

A display panel according to an embodiment of the present disclosure includes a substrate having a display area and a non-display area surrounding the display area, a plurality of gate lines and a plurality of data lines provided on the substrate, the plurality of gate lines and the plurality of data lines intersecting each other in the display area to define a plurality of pixel areas, a plurality of pixel electrodes provided respectively in the plurality of pixel areas, a plurality of common electrodes overlapping the plurality of pixel electrodes, the plurality of common electrodes being located on a different layer than the plurality of pixel electrodes, a plurality of touch lines connected respectively to the plurality of common electrodes, a plurality of data pad electrodes provided in the non-display area, the plurality of data pad electrodes being electrically connected to the plurality of data lines, and a plurality of touch pad electrodes provided in the non-display area, the plurality of touch pad electrodes being electrically connected to the plurality of touch lines.

A display device according to an embodiment of the present disclosure includes a first substrate and a second substrate opposite each other, each of the first substrate and the second substrate having a display area and a non-display area surrounding the display area, a plurality of gate lines and a plurality of data lines provided in the display area on the substrate, the plurality of gate lines and the plurality of data lines intersecting each other to define a plurality of pixel areas, a plurality of pixel electrodes provided respectively in the plurality of pixel areas, a plurality of common electrodes overlapping the plurality of pixel electrodes, the plurality of common electrodes being located on a different layer than the plurality of pixel electrodes, a plurality of touch lines connected respectively to the plurality of common electrodes, a plurality of data pad electrodes provided in the non-display area, the plurality of data pad electrodes being electrically connected to the plurality of data lines, a plurality of touch pad electrodes provided in the non-display area, the plurality of touch pad electrodes being electrically connected to the plurality of touch lines, and a liquid crystal layer provided between the first substrate and the second substrate.

### BRIEF DESCRIPTION OF THE DRAWINGS

The accompanying drawings, which are included to provide a further understanding of the present disclosure and are incorporated in and constitute a part of this application, illustrate embodiment(s) of the present disclosure and together with the description serve to explain the principle of the present disclosure. In the drawings:

FIG. 1 is a plan view showing a display device according to an embodiment of the present disclosure;

FIG. 2 is a plan view showing a common electrode and a touch line in a display area of a substrate of FIG. 1 according to an embodiment of the present disclosure;

FIG. 3 is an enlarged plan view showing connection between the touch line and a drive chip at A region of FIG. 1 according to an embodiment of the present disclosure;

FIG. 4 is a plan view showing B of FIG. 3 according to an embodiment of the present disclosure;

FIG. 5 is a sectional view taken along line I-I′ of FIG. 4 according to an embodiment of the present disclosure;

FIG. 6 is a sectional view taken along line I-I′ of FIG. 4 according to another embodiment of the present disclosure;

FIG. 7 is an enlarged plan view showing a pad electrode overlapping a drive chip at a C region of FIG. 3 according to an embodiment of the present disclosure;

FIG. 8 is a sectional view taken along line II-II′ of FIG. 7 according to an embodiment of the present disclosure;

FIG. 9 is a sectional view taken along line III-III′ of FIG. 7 according to an embodiment of the present disclosure; and

FIG. 10 is a sectional view showing a pad electrode overlapping a drive chip according to each of a first experimental example and a second experimental example.

### DETAILED DESCRIPTION

Hereinafter, embodiments of the present disclosure will be described with reference to the accompanying drawings. Wherever possible, the same reference numbers will be used throughout the drawings to refer to the same or like parts, unless otherwise specified. In the following description of the present disclosure, where the detailed description of the relevant known steps, elements, functions, technologies, and configurations can unnecessarily obscure an important point of the present disclosure, a detailed description of such steps, elements, functions, technologies, and configurations may be omitted. In addition, the names of elements used in the following description are selected in consideration of clarity of description of the specification, and can differ from the names of elements of actual products.

The shapes, sizes, ratios, angles, numbers, and the like, which are illustrated in the drawings to describe various example embodiments of the present disclosure are merely given by way of example. The disclosure is not limited to the illustrations in the drawings. In the present disclosure, where terms such as “including,” “having,” “comprising,” and the like are used, one or more components can be added, unless the term, such as “only,” is used. The terminology used herein is to describe particular aspects and is not intended to limit the present disclosure. As used herein, the terms “a” and “an” used to describe an element in the singular form is intended to include a plurality of elements. An element described in the singular form is intended to include a plurality of elements, and vice versa, unless the context clearly indicates otherwise.

In construing a component or numerical value, the component or the numerical value is to be construed as including an error or tolerance range even where no explicit description of such an error or tolerance range is provided.

In describing the various example embodiments of the present disclosure, where the positional relationship between two elements is described using terms, such as “on”, “above”, “under” and “next to”, at least one intervening element can be present between the two elements, unless “immediate(ly)” or “direct(ly)” or “close(ly) is used. It will be understood that when an element or layer is referred to as being “connected to”, or “coupled to” another element or layer, it can be directly connected to or coupled to the other element or layer, or one or more intervening elements or layers can be present.

In describing the various example embodiments of the present disclosure, when terms such as “after,” “subsequently,” “next,” and “before,” are used to describe the temporal relationship between two events, another event can occur therebetween, unless a more limiting term, such as “just,” “immediate(ly),” or “directly” is used.

In describing the various example embodiments of the present disclosure, terms such as “first” and “second” can be used to describe a variety of components. These terms aim to distinguish the same or similar components from one another and do not limit the components. Accordingly, throughout the specification, a “first” component can be the same as a “second” component within the technical concept of the present disclosure, unless specifically mentioned otherwise.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in a co-dependent relationship.

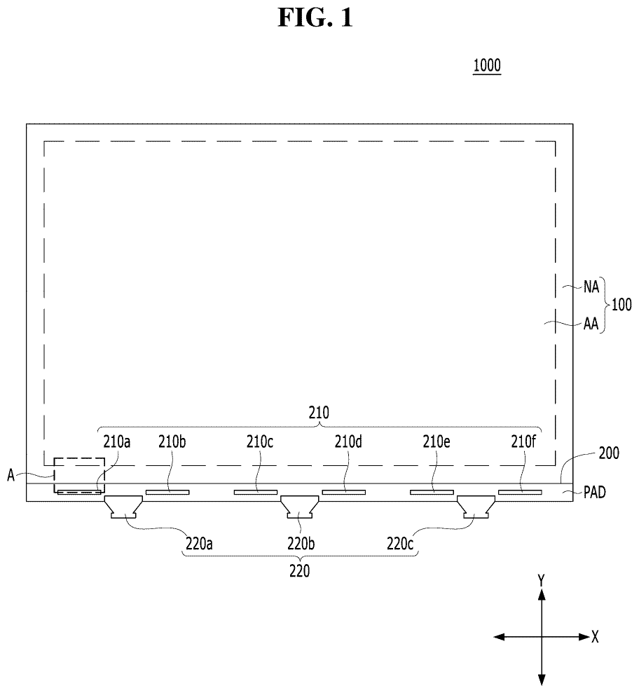

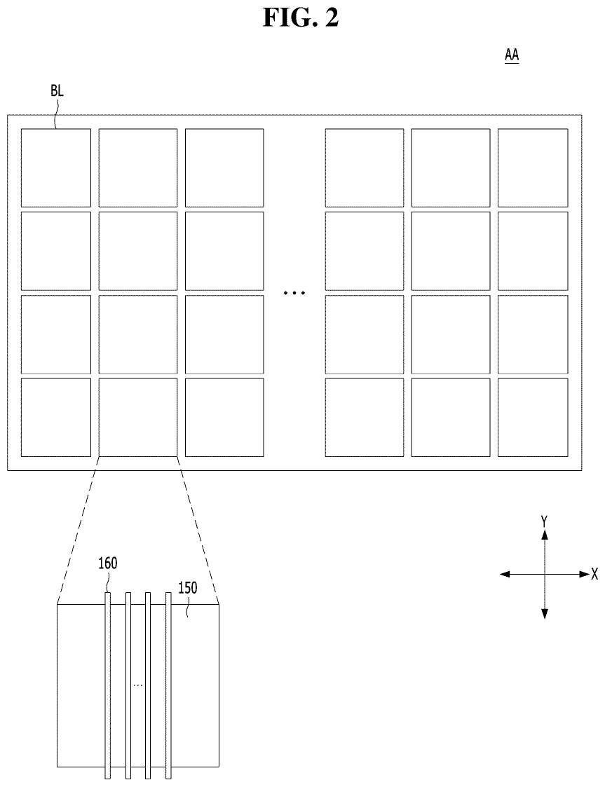

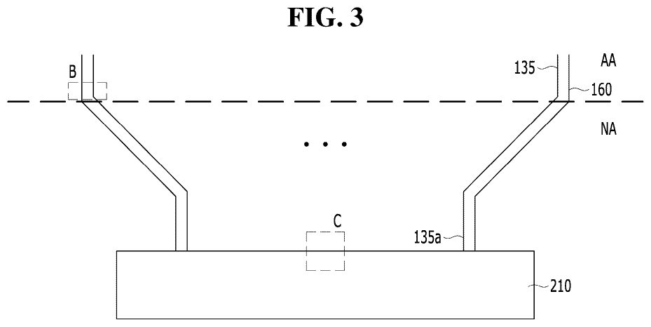

FIG. 1 is a plan view showing a display device according to an embodiment of the present disclosure. FIG. 2 is a plan view showing a common electrode and a touch line in a display area of a substrate of FIG. 1 according to an embodiment of the present disclosure. FIG. 3 is an enlarged plan view showing connection between the touch line and a drive chip at A region of FIG. 1 according to an embodiment of the present disclosure.

As shown in FIGS. 1 to 3, a display device 1000 according to an embodiment of the present disclosure may include a first substrate 100 and a second substrate 200 opposite each other.

The display device may include a liquid crystal layer provided between the first and second substrates 100 and 200.

Each of the first substrate 100 and the second substrate 200 includes a display area AA and a non-display area NA surrounding the display area AA.

The display area AA between the first substrate 100 and the second substrate 200 may be filled with liquid crystals to provide the liquid crystal layer.

The first and second substrates 100 and 200 may be coupled to each other in the state in which a seal material is provided at areas of the first and second substrates 100 and 200 facing each other such that the liquid crystals are received therein. The seal material may be provided so as to surround the display area AA.

The display area AA of each of the first and second substrates 100 and 200 is provided with a plurality of pixel areas to display an image.

The first substrate 100 may protrude farther outward than the second substrate 200 and may be provided with a pad unit PAD in an area exposed from the second substrate 200.

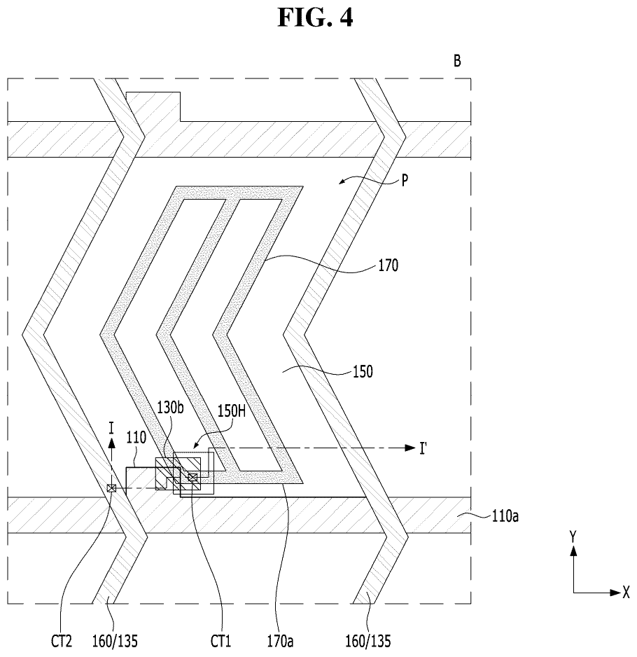

The display area AA of the first substrate 100 is provided with a plurality of gate lines (see 110a in FIG. 4) and data lines 135 intersecting each other, and a pixel area is provided in each of areas where the plurality of gate lines and data lines 135 intersect.

In addition, the display device 1000 according to the embodiment of the present disclosure is provided with a plurality of block electrodes BL for touch sensing in the display area AA, as shown in FIG. 2. The plurality of block electrodes BL is provided in the display area AA so as to be spaced apart from each other. The area occupied by each block electrode BL is an area covering several pixel areas. For example, each block electrode BL may cover an area including a plurality of gate lines and a plurality of data lines. The block electrode BL may have an individual size that is at least smaller than one touch point of a finger or input means for area-specific touch sensing in the display device 1000. A plurality of block electrodes BL is provided in the display area AA in a first direction (X direction) and a second direction (Y direction) intersecting each other.

The plurality of block electrodes BL may use any one of the common electrode 150 and the pixel electrode configured to form an electric field in the pixel area. The example shown in FIG. 2 is an example of using the common electrode 150 as a block electrode BL for touch sensing.

On each block electrode BL, touch lines 160 overlap each other, and the touch lines 160 extend to the pad unit of the non-display area NA.

At least one touch line 160 is required for each block electrode BL to receive an independent signal from the pad unit PAD. The touch line 160 may extend to the pad unit PAD for each block electrode BL to receive a touch signal, or a touch sensing signal detected by the block electrode BL or 150 may be transmitted to the pad unit PAD via the touch line 160.

Thus, block electrodes adjacent to the pad unit PAD may at least overlap the touch line 160 connected thereto, and may also overlap another touch line 160 located in the same row that is not electrically connected thereto. Here, a touch line 160 connected to another block electrode located in the same row may not be connected to the block electrode adjacent to the pad unit PAD.

In some cases, any one of the block electrodes may more overlap the touch line 160 than the other block electrodes to utilize space.

For example, the overlapping touch lines 160 in each block electrode may be connected on the same layer and receive the same signal.

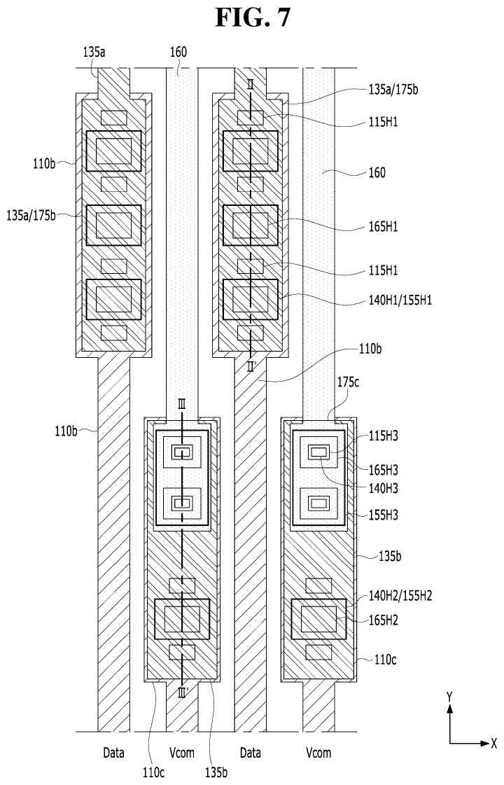

The pad unit PAD may include a data pad electrode (see Data in FIG. 7) electrically connected to the data line 135 provided in the display area AA and a touch pad electrode (see Vcom in FIG. 7) electrically connected to the touch line 160.

The data pad electrode and the touch pad electrode may be connected to drive chips 210 (210a, 210b, 210c, 210d, 210e, and 210f), each including an integrated circuit IC. Each of the drive chips 210a, 210b, 210c, 210d, 210e, and 210f may have a base substrate and a lead electrode provided on the base substrate so as to be opposite the data pad electrode and the touch pad electrode.

Flexible printed circuit films (FPC) 220 (220a, 220b, and 220c) may be further provided between the neighboring drive chips 210a, 210b, 210c, 210d, 210e, and 210f, and may be connected outwardly to a circuit board (not shown) including a timing controller. In addition, the flexible printed circuit films 220 (220a, 220b, and 220c) may be connected to adjacent drive chips 210 (210a, 210b, 210c, 210d, 210e, and 210f) on the substrate 100 and may transmit and receive signals.

As shown in FIG. 3, the data line 135 may have a data link wire 1351 integral with the data line 135 between the data line and the pad unit PAD and may be connected to the drive chips 210 (210a, 210b, 210c, 210d, 210e, and 210f).

The touch line 160 may extend directly to the pad unit PAD or may be connected to the drive chips 210 (210a, 210b, 210c, 210d, 210e, and 210f) via a separate touch link wire.

To increase the transmission efficiency of the display device, the touch line 160 may disposed in a state of overlapping the data line 135 in the display area AA.

In addition, since the gate lines, the data lines 135, and the touch lines 160 included in the display area AA are gathered in the pad unit PAD and connected to the drive chips 210 (210a, 210b, 210c, 210d, 210e, and 210f) or the flexible printed circuit films 220 (220a, 220b, and 220c) in the non-display area NA, jump connection may be made using a wire on another layer as a pattern in areas where the lines are densely disposed to avoid interference between the respective lines. For example, the data line 135 may extend from the display area AA, may be connected to a data link line 135a via the non-display area NA, and may be connected to the drive chip 210. The data link line 135a may be an integrated and connected layer on the same layer as the data line 135 or may be connected to a wire of a different layer than the data line 135.

Hereinafter, a display device according to an embodiment of the present disclosure will be described.

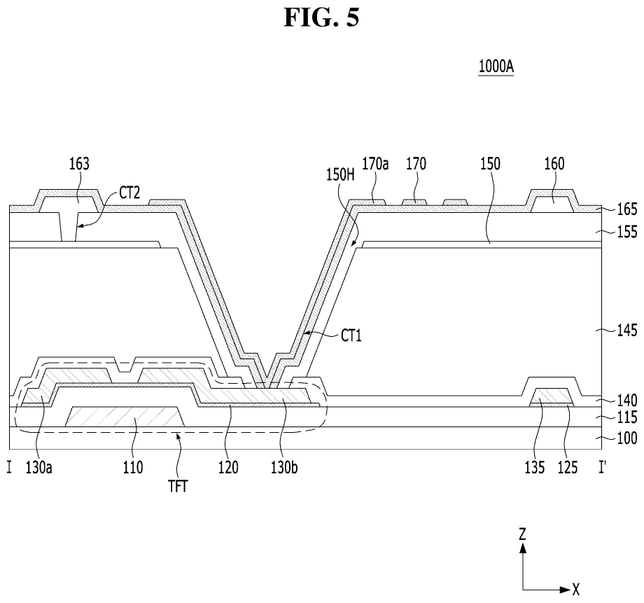

FIG. 4 is a plan view showing B of FIG. 3 according to one embodiment, and FIG. 5 is a sectional view taken along line I-I′ of FIG. 4 according to one embodiment. FIG. 4 shows one pixel area in the display area.

Referring to FIGS. 1 to 5, a display device 1000A according to an embodiment of the present disclosure includes a plurality of gate lines 110a and a plurality of data lines 135 provided on a first substrate 100 and intersecting each other to define a plurality of pixel areas P, a plurality of pixel electrodes 170 provided in the plurality of pixel areas, a plurality of common electrodes 150 overlapping the plurality of pixel electrodes 170 but located on a different layer than the plurality of pixel electrodes, and a plurality of touch lines 160 connected to the plurality of common electrodes 150.

At the intersection between the gate line 110a and the data line 135, a thin-film transistor TFT is provided to enable on/off and gradation representation of each pixel area depending on voltage applied thereto.

The thin-film transistor TFT may include a gate electrode 110 provided at a predetermined position on the substrate 100, a first active layer 120 overlapping the gate electrode 110, and a source electrode 130a and a drain electrode 130b connected to both sides of the first active layer 120.

Between the gate electrode 110 and the first active layer 120, a first insulating film 115, which functions as a gate insulating film, may be interposed to insulate the gate electrode 110 and the first active layer 120 from each other.

The gate line 110a may be integral with the gate electrode 110. In addition, the gate electrode 110 may protrude from the gate line 110a toward the pixel area.

The source electrode 130a may be integral with the data line 135, and the drain electrode 135 may be spaced apart from the source electrode 130a.

A second active layer 125 may be further provided under the data line 135. In some cases, the second active layer 125 may be omitted.

Each of the first and second active layers 120 and 125 may be formed including at least one of an oxide semiconductor, amorphous silicon, and crystalline silicon.

A second insulating film 140 is provided so as to cover the thin film transistor TFT and the data line 135.

A planarization film 145 made of an organic insulating material configured to planarize the surface is provided on the second insulating film 140.

Each of the planarization film 145 and the second insulating film 140 is provided with a hole configured to allow a part of an upper part of the drain electrode 130b to be exposed therethrough. This is for connection between the drain electrode 130b and a pixel connection electrode 170a provided in the uppermost layer.

The common electrodes 150 divided into a shape covering the plurality of pixel areas described with reference to FIG. 2 are provided on the planarization film 145. The common electrode 150 may have a common electrode hole 150H larger than the hole of the planarization film 145 to prevent electrical short circuit with the pixel electrode 170. The common electrode 150 functions as the block electrode BL described with reference to FIG. 2.

A third insulating film 155 is provided on the common electrode 150. The third insulating film 155 may be provided with a common electrode connection hole CT2 configured to allow a part of the common electrode 150 to be exposed therethrough.

A touch line 160 overlapping the data line 135 and a touch connection electrode 163 connected to the common electrode 150 via the common electrode connection hole CT2 are provided on the third insulating film 155. When the common electrode connection hole CT2 of the third insulating film 155 is provided, the third insulating film may further be provided with a hole configured to allow an upper part of the drain electrode 130b in the hole provided in the planarization film 145 to be exposed therethrough.

A fourth insulating film 165 is provided on the touch line 160 and the touch connection electrode 163. When the fourth insulating film 165 is formed, a pixel electrode connection hole CT1 configured to allow an upper part of the drain electrode 130b in the hole provided in the planarization film 145 to be exposed therethrough may be formed.

A pixel connection electrode 170a provided on the fourth insulating film 165 through the pixel electrode connection hole CT1 and a pixel electrode 170 integral with and branched from the pixel connection electrode 170a are further provided.

The pixel electrode 170, which is located at the uppermost side on the substrate 100, is connected to the drain electrode 130b via the pixel electrode connection hole CT1.

The overlapping pixel electrodes 170 in the pixel area P may each receive a pixel voltage through the drain electrode 130b in the pixel area P, and the common electrode 150 may receive a common voltage through the touch line 160/touch connection electrode 163. An electric field is generated according to the application of the pixel voltage and the common voltage, and the disposition state of the liquid crystals between the first substrate 100 and the second substrate 200 is varied, whereby the light transmittance of a liquid crystal cell may be adjusted and gradation may be realized.

The display device 1000A of the structure shown in FIG. 5 enables liquid crystal control by a vertical electric field in the area where the pixel electrode 170 and the common electrode 150 overlap each other, and liquid crystal control by a horizontal electric field between the pixel electrode 170 and the common electrode 150 in a plane in the area between the branched pixel electrodes 170, whereby the liquid crystals may be controlled as a whole without non-driving of the liquid crystals in the pixel area, thus enabling high quality display.

Here, since the common electrode 150 can also be used for touch sensing, the electric field drive and touch sensing may be time-division driven by separating the timing when the common voltage is applied and the timing when touch sensing is performed.

Each of the first to fourth insulating films 115, 140, 155, and 165 is made of an inorganic insulating material. For example, the inorganic insulating material may include at least one of a silicon oxide film (SiOx), a silicon nitride film (SiNx), and a silicon oxynitride film (SiOxNy), or a multilayer film formed by stacking the inorganic films.

The planarization film 145 may include an organic material. The organic material may include at least one of an acrylic resin, a phenolic resin, a polyimide resin, an unsaturated polyester resin, a polyamide resin, benzocyclobutene, a polyphenylene resin, and a polyphenylene sulfide resin.

The pixel electrode 170, the pixel connection electrode 170a, and the common electrode 150 may be transparent electrodes, such as indium tin oxide (ITO), indium zinc oxide (IZO), and indium tin zinc oxide (ITZO), for transparent display in the pixel area P when an electric field is generated.

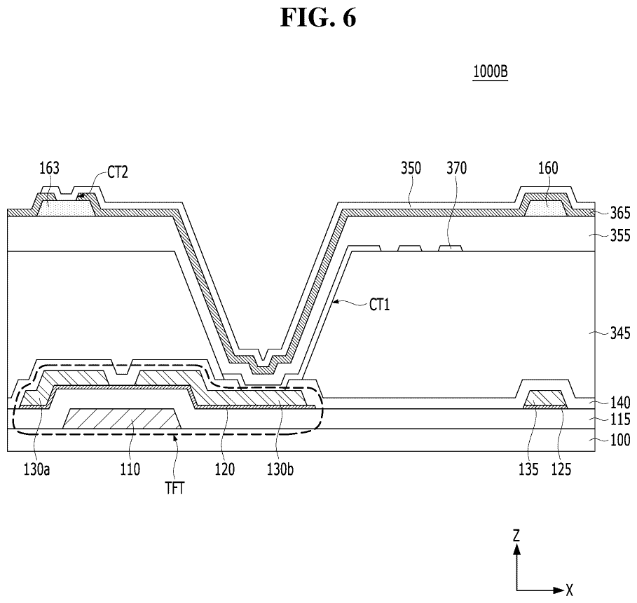

FIG. 6 is a sectional view taken along line I-I′ of FIG. 4 according to another embodiment of the present disclosure.

As shown in FIG. 6, a display device 1000B according to another embodiment of the present disclosure is configured such that the locations of a pixel electrode 370 and a common electrode 350 are reversed up and down compared to the display device 1000A of FIG. 5.

That is, the pixel electrode 370 is connected to a drain electrode 130b via a direct pixel electrode connection hole CT1 of a planarization film 345.

In addition, a third insulating film 355 on the planarization film 345 is provided entirely covering the pixel electrode 370 without a hole or connection hole.

A touch line 160 and a touch connection electrode 163 are provided on the third insulating film 355.

A fourth insulating film 365 configured to cover the touch line 160 and having a common electrode connection hole CT2 configured to allow a part of an upper part of the touch connection electrode 163 to be exposed therethrough is provided on the third insulating film 355.

In the display device 1000B of FIG. 6, the uppermost electrode on the substrate 100 is a common electrode 350. In this case, the common electrode 350 may be shaped to cover a plurality of pixel areas, such as the shape of the block electrode BL in FIG. 2. Since the common electrode 350 is located at the uppermost side of the substrate 100 and the common electrode 350 is isolated from the pixel electrode 370 in the state in which the third and fourth insulating films 355 and 365 are interposed therebetween, the common electrode 350 may be formed to cover the entire pixel area P without a separate hole.

The common electrode 350 may receive a common voltage or a touch sensing signal through the touch line 160 and the touch connection electrode 163 thereunder.

In FIG. 6, the pixel electrode 370 have a branched shape, but embodiments of the present disclosure are not limited thereto. The common electrode 350 in the pixel area may have a branched shape. If any one of the pixel electrode 370 and the common electrode 350 is patterned by being branched including a slit and the other is formed so as to overlap both the slit and the branched pattern, the same effect of controllable liquid crystals in all or most of the pixel areas may be achieved.

Each of the third and fourth insulating films 355 and 365 is made of an inorganic insulating material. For example, the inorganic insulating material may include at least one of a silicon oxide film (SiOx), a silicon nitride film (SiNx), and a silicon oxynitride film (SiOxNy), or a multilayer film formed by stacking the inorganic films.

The planarization film 345 may include an organic material. The organic material may include at least one of an acrylic resin, a phenolic resin, a polyimide resin, an unsaturated polyester resin, a polyamide resin, benzocyclobutene, a polyphenylene resin, and a polyphenylene sulfide resin.

The pixel electrode 370, the pixel connection electrode 370a, and the common electrode 350 may be transparent electrodes, such as indium tin oxide (ITO), indium zinc oxide (IZO), and indium tin zinc oxide (ITZO), for transparent display in the pixel area P when an electric field is generated.

In the display panel and the display device including the in-cell function unit according to the embodiments of the present disclosure, at least three wiring layers are used in the pixel area and are doubly provided with transparent electrodes. That is, referring to FIGS. 4 to 7, at least three wiring layers, such as the gate electrode 110, the data line 135, and the touch line 160, are used in the pixel area. In addition, the transparent pixel electrode 170 or 370 and the common electrode 150 or 350 forming a horizontal electric field are configured in the pixel area. Furthermore, as shown in FIGS. 7 to 9, which will be described below, a first wiring layer 110b on the same layer as the gate electrode 110, a second wiring layer 135b on the same layer as the data line 135, and a third wiring layer 170c on the same layer as the touch line 160 are used in the pad unit.

The area where the drive chip 210 of the pad unit PAD is located includes a data pad electrode and a touch pad electrode.

If the shape of the connection hole between the wires in the pad electrode is such that the wiring layers are directly connected from top to bottom without any insulating film between the three wiring layers, the step between the connection hole and the area around the connection hole becomes large, and the area with the large step may be observed as a light leakage defect.

The drive chip 210 is bonded to the pad unit PAD of the substrate 100, and thermal bonding is performed at the time of bonding, the substrate 100 is relatively excessively bent due to the difference in thermal expansion rate between the substrate 100 and the drive chip 210 at the time of bonding, and it may be difficult to restore the substrate 100 after the bonding is completed. Furthermore, such restoration is more difficult if the step between the connection hole of the pad electrode and the periphery thereof is large.

In addition, if the step between the connection hole of the pad electrode and the periphery thereof is large, poor connection may occur.

The display panel and the display device according to the embodiments of the present disclosure may reduce the step between the connection holes by disposing the connection holes of two adjacent wiring layers at different planar positions when the pad electrode includes three or more wiring layers.

The display panel described below may be in a form in which the liquid crystal layer and the second substrate 200 of the display device 1000 are omitted.

The display panel described below includes a plurality of pixels in the display area AA and a pad unit PAD in the non-display area NA, wherein the step in the pad electrode including the plurality of wiring layers may be minimized, whereby it is possible to prevent a light leakage defect and an indentation defect.

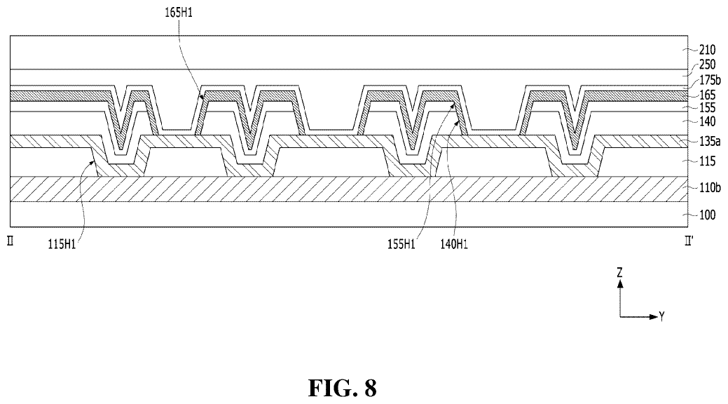

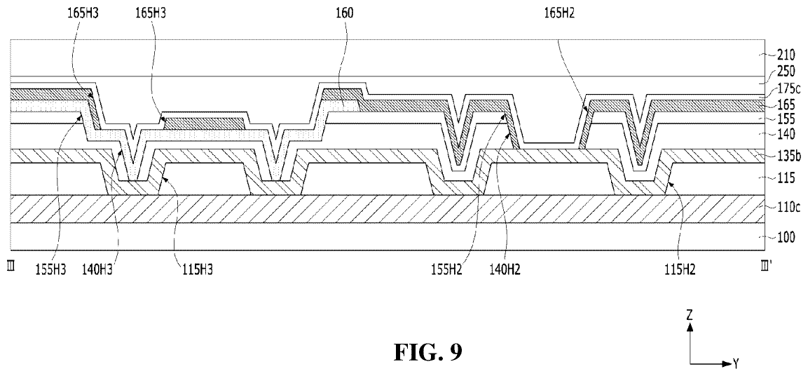

FIG. 7 is an enlarged plan view showing a pad electrode overlapping a drive chip at a C region of FIG. 3 according to one embodiment, FIG. 8 is a sectional view taken along line II-II′ of FIG. 7 according to one embodiment, and FIG. 9 is a sectional view taken along line III-III′ of FIG. 7 according to one embodiment.

As shown in FIGS. 7 to 9, the display panel and the display device according to the embodiments of the present disclosure may include a plurality of data pad electrodes Data electrically connected to the plurality of data lines 135 and a plurality of touch pad electrodes Vcom electrically connected to the plurality of touch lines 160 in the area corresponding to the drive chip 210 of the pad unit PAD.

As shown in FIG. 7, the plurality of touch pad electrodes Vcom and the plurality of data pad electrodes Data are alternately disposed in parallel.

The touch pad electrode Vcom and the data pad electrode Data adjacent thereto may have planar convex portions at different positions and may have connection holes in the convex portions such that each wiring layer is electrically connected to the touch line 160 and the data line 135. This is to avoid interference with each other when bonding with the drive chip 210. The touch pad electrode Vcom and the data pad electrode Data may be integrally connected to the touch line 160 and the data line 135 with some of the plurality of wiring layers provided on each being located on the same layer.

As shown in FIGS. 7 and 8, the plurality of data pad electrodes Data may each include a first wiring layer 110b, a second wiring layer 135a, and a third wiring layer 175b overlapping each other, wherein a first connection hole 115H1 of the first wiring layer 110b and the second wiring layer 135a and a second connection hole 165H1 of the second wiring layer 135a and the third wiring layer 175b may be provided at different planar positions.

In the direction along line II-II′ of FIGS. 7 and 8, the first wiring layer 110b is elongated in the Y direction on the substrate 100 at the plurality of data pad electrodes Data from top to bottom. The first wiring layer 110b is connected to the second wiring layer 135a through the first connection hole 115H1, and the second wiring layer 135a is connected to the third wiring layer 175b through the second connection hole 165H1.

The first wiring layer 110b is located on the same layer as the gate line 110a.

The second wiring layer 135a is formed on the same layer as the data line 135 and may continuously extend from the data line 135 to the pad unit PAD.

Each of the first and second wiring layers 110b and 135a is made of a conductive metal material, as in the gate line 110a and the data line 135. For example, the conductive metal material may include at least one of an aluminum-based metal, such as aluminum (Al) or an aluminum alloy, a silver-based metal, such as silver (Ag) or a silver alloy, a copper-based metal, such as copper (Cu) or a copper alloy, a molybdenum-based metal, such as molybdenum (Mo) or a molybdenum alloy, chromium (Cr), tantalum (Ta), neodymium (Nd), and titanium (Ti). In some cases, when different types of active layers are provided on the substrate 111, one of the active layers may be a conductive layer.

In addition, the third wiring layer 175b may be formed on the same layer as the pixel electrode 170 or the common electrode 150, and may be a transparent electrode such as ITO, IZO, or ITZO.

In the data pad electrode Data, each of the first connection hole 115H1 through which the first wiring layer 110b and the second wiring layer 135a are connected to each other and the second connection hole 165H1 through which the second wiring layer 135a and the third wiring layer 175b are connected to each other may include at least one conductive metal material at the connection portion to reduce the connection resistance.

In the display panel and the display device according to the embodiments of the present disclosure, the data pad electrode Data is provided together with the first wiring layer 110b and the third wiring layer 175b there above and thereunder, rather than a single configuration of the second wiring layer 135a connected to the data line 135.

In addition, the first connection hole 115H1 is provided with second to fourth insulating films 140, 155, and 165 between the second wiring layer 135a and the third wiring layer 175b. In the area where the first connection hole 115H1 is located, the second to fourth insulating films 140, 155, and 165, are provided together with the first to third wiring layers 110b, 135a, and 175b, whereby a step having a thickness of the first insulating film 115 is formed between the area and the periphery thereof, and therefore the step between the area of the first connection hole 115H1 and the periphery thereof is very small.

Around the second connection hole 165H1, holes 140H1 and 155H1 may be further provided in the second insulating film 140 and the third insulating film 155 so as to have a larger diameter than the second connection hole 165H1 in order to expose the second wiring layer 135a. The holes 140H1 and 155H1 may have the same size and may be formed in the same process.

That is, in the second connection hole 165H1, the second to fourth insulating films 140, 155, and 165 are further removed compared to the periphery thereof, but are necessary configurations for the second and third wiring layers 135a, 175b to overlap each other, and the second wiring layer 135a has the first insulating film 115 interposed between the second wiring layer and the first wiring layer 110b, whereby the second wiring layer is located at a relatively high position compared to a structure in which the plurality of wiring layers are connected by removing all of the insulating films.

Meanwhile, the connection portion of the data pad electrode Data is located in the upper row with reference to FIG. 7, and the connection portion of the touch pad electrode Vcom is located in the lower row with reference to FIG. 7, whereby the connection portions and are provided at different positions. The second wiring layer 135a located on the data pad electrode Data may extend directly to the data line 135 and be located in the upper row.

As shown in FIGS. 8 and 9, the data pad electrode Data and the touch pad electrode Vcom are opposite the drive chip 210, and a lead electrode (not shown) may be provided on the surface of the drive chip 210 facing the substrate 100.

Between the drive chip 210 and the uppermost side of the substrate 100, i.e., the third wiring layer 175b, an anisotropic conductive film or anisotropic conductive adhesive is provided such that the lead electrode of the drive chip 210 and the data pad electrode Data and the touch pad electrode Vcom are connected to each other at each point.

The touch pad electrode Vcom adjacent to the data pad electrode Data may have a configuration of a single layer of touch line 160 in the upper row and the following configuration at the connection portion in the lower row.

As shown in FIGS. 7 and 9, the touch line 160 extending from the display area AA to the non-display area NA is connected to the touch pad electrode Vcom, which is different from the data pad electrode Data in that the touch line 160 is further provided.

As shown in FIGS. 7 and 9, each of the plurality of touch pad electrodes Vcom includes a first wiring layer 110c, a second wiring layer 135b, and a third wiring layer 175c overlapping each other, wherein a first connection hole 115H2 of the first wiring layer 110c and the second wiring layer 135b and a second connection hole 165H2 of the second wiring layer 135b and the third wiring layer 175c may be located at different planar positions.

In the direction along line III-III′ of FIGS. 7 and 9, a touch line 160 is further provided between the third insulating film 155 and the fourth insulating film 165 up to a part of the top of the planar convex portion for connection.

In the area where the touch line 160 is located, a third connection hole 140H3 having a size smaller than the first connection hole 115H2 is provided in the second insulating film 140 in a part of the inside of the first connection hole 115H3, whereby the touch line 160 may be connected to the second wiring layer 135b. In addition, a second connection hole 165H3 larger than at least the third connection hole 140H3 is provided in the fourth insulating film 165, whereby the third wiring layer 175c may be connected to the touch line 160 through the hole.

That is, the touch line 160 is connected to the upper third wiring layer 175c through the second connection hole 165H3 of the fourth insulating film 165 and is connected to the second wiring layer 135b through the third connection hole 140H3 provided in the second insulating film 140.

Here, the third connection hole 140H3 is formed so as to be smaller than the first connection hole 115H3 such that the second insulating film 140 is filled around the first connection hole 115H2, and an increase in height difference between the first and third connection hole 115H2 and 140H3 and the periphery thereof may be partially prevented.

In the touch pad electrode Vcom, the area where the touch line 160 is not located may have the same layer configuration as the data pad electrode Data described above. That is, in the downward direction of the convex portion along line III-III′ of FIG. 7 where the touch line 160 is not located, the first wiring layer 110c in the touch pad electrode Vcom is disposed on the substrate 100 so as to extend in the Y direction. The first wiring layer 110c is connected to the second wiring layer 135b through the first connection hole 115H2, and the second wiring layer 135b is connected to the third wiring layer 175c through the second connection hole 165H2.

The data pad electrode Data and the touch pad electrode Vcom have the same or similar steps in the first connection holes 115H1 and 115H2 and the second connection holes 165H1 and 165H2 of the same shape and have small steps from the periphery by having at least three wiring layers and at least one insulating film in each area.

In addition, the third wiring layer 175c on the third connection hole 140H3 in the area where the touch line 160 is located, among the areas of the touch pad electrode Vcom, may further have a layer of the touch line 160 compared to the third wiring layer 175c on the area of the second connection hole 165H2 where the touch line 160 is not located, and the third connection hole 140H3 in the first connection hole 115H3 may have a relatively higher height by including the second insulating film 140. It can be seen that each of the third wiring layer 175c on the third connection hole 140H3 in the area of the touch pad electrode Vcom where the touch line 160 is located and the third wiring layer 175c on the area of the second connection hole 165H2 where the touch line 160 is not located has a height of approximately 1000 Å or less, whereby the step between the areas is small.

Particularly, in the display panel and the display device according to the embodiments of the present disclosure, the first connection holes 115H1, 115H2, and 115H3 for connecting the first wiring layers 110b and 110c to the second wiring layers 135a and 135b and the second connection holes 165H1, 165H2, and 165H3 for connecting the second wiring layer 135a and 135b to the third wiring layer 175b and 175c may not overlap each other and may be disposed at different positions to prevent a large step in the area where the removal of the insulating film by the through structure of the plurality of electrodes occurs.

In addition, the touch line 160 may be provided with a third connection hole 140H3 having a smaller size in the area in the first connection hole 115H3, whereby a part of the second insulating film 140 remains around the third connection hole 140H3 in the first connection hole 115H3, which differs from the simple through structure of the touch line connection portion and reduces the step from the periphery.

In the display panel and the display device according to the embodiments of the present disclosure, therefore, the step at the connection portion of the data pad electrode Data and the touch pad electrode Vcom may be reduced to prevent poor connection when bonding with the drive chip 210 or the flexible circuit film.

In the display panel and the display device according to the embodiments of the present disclosure, the area-specific step at the data pad electrode and the touch pad electrode may be reduced, whereby it is possible to prevent an indentation defect and a light leakage defect, and therefore it is possible to improve reliability of the display device.

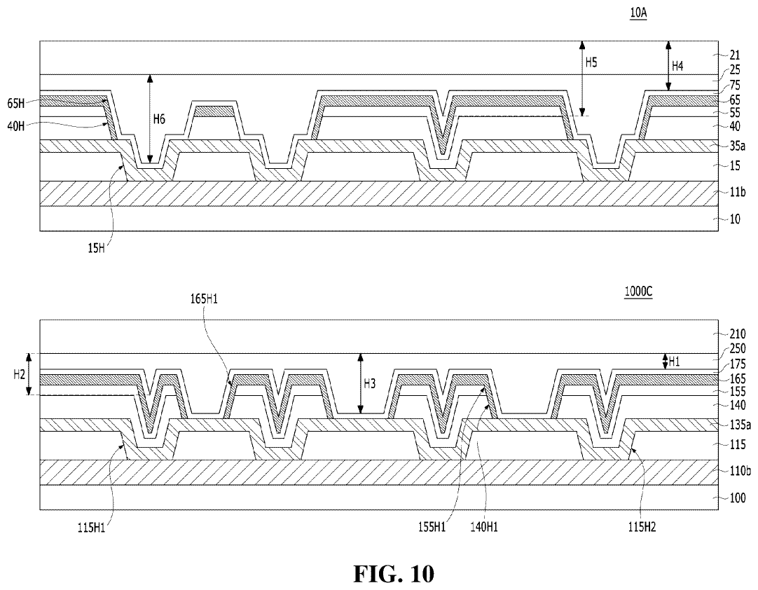

FIG. 10 is a sectional view showing a pad electrode overlapping a drive chip according to each of a first experimental example and a second experimental example.

Each of the first and second experimental examples 10A and 1000C shows the connection portion of the data pad electrode in the y-axis direction, as shown in FIG. 7.

The second experimental example 1000C shows the display device according to FIG. 8, wherein the highest area of the surface on the substrate 100 is spaced apart from the drive chip 210 by a first distance H1 when bonding with the drive chip 210 via the anisotropic conductive adhesive 250. In the highest area of the substrate 100, the first wiring layer 110b, the first insulating film 115, the second wiring layer 135a, the second insulating film 140, the third insulating film 155, the fourth insulating film 165, and the third wiring layer 175b are sequentially disposed.

In the second experimental example 1000C, the second highest area on the substrate 100 is the area where the first connection hole 115H1 is located, and the first wiring layer 110b, the second wiring layer 135a, the second insulating film 140, the third insulating film 155, the fourth insulating film 165, and the third wiring layer 175b are sequentially disposed on the substrate 100. The drive chip 210 and the third wiring layer 175b are spaced apart from each other by a second distance H2.

In the second experimental example 1000C, the third highest area on the substrate 100 is the area where the second connection hole 165H1 is located, and the first wiring layer 110b, the first insulating film 115, the second wiring layer 135a, and the third wiring layer 175b are sequentially disposed on the substrate 100. The drive chip 210 and the third wiring layer 175b are spaced apart by a third distance H3.

On the other hand, the first experimental example 10A is a structure in which the first to third wiring layers 11b, 35a, and 75 are provided on the substrate 10, and the first to third wiring layers 11b, 35a, and 75 are connected to each other at the connection portions without the insulating films 15, 40, 55, and 65 interposed therebetween, wherein the third wiring layer 75 is spaced apart from the drive chip 21 in the area where the connection hole is located by a fourth distance H4.

The fourth distance H4 has a difference between the periphery and the sum of the thickness the insulating films 15, 40, 55, and 65, and has a difference from the periphery of 10000 Å or more, which means that the step at the connection portion is large. When connected to the drive chip 21 via the anisotropic conductive adhesive 25, therefore, the anisotropic conductive adhesive 25 is not sufficiently filled in the fourth distance H4 due to the step from the periphery, whereby connection failure may occur. In the first experimental example 10A, the non-connection in the fourth distance H4 may be observed as a light leakage defect in which the lower pad unit PAD of the display panel is observed to be partially bright.

In the display device 1000C according to the embodiment of the present disclosure, a pair of adjacent wiring layers has connection holes disposed at different planar positions, whereby it is possible to reduce the step between each connection hole and the area adjacent thereto and to reduce the area-specific step of the data pad electrode and the touch pad electrode, and therefore it is possible to prevent an indentation defect and a light leakage defect, thereby improving reliability of the display device.

A display panel according to one embodiment of the present disclosure may comprise a substrate having a display area and a non-display area surrounding the display area, a plurality of gate lines and a plurality of data lines provided on the substrate, the plurality of gate lines and the plurality of data lines intersecting each other in the display area to define a plurality of pixel areas, a plurality of pixel electrodes provided respectively in the plurality of pixel areas, a plurality of common electrodes overlapping the plurality of pixel electrodes, the plurality of common electrodes being located on a different layer than the plurality of pixel electrodes, a plurality of touch lines connected respectively to the plurality of common electrodes, a plurality of data pad electrodes provided in the non-display area, the plurality of data pad electrodes being electrically connected to the plurality of data lines and a plurality of touch pad electrodes provided in the non-display area, the plurality of touch pad electrodes being electrically connected to the plurality of touch lines. Each of the plurality of data pad electrodes and the plurality of touch pad electrodes may comprise a first wiring layer, a second wiring layer, and a third wiring layer overlapping each other. And each of the plurality of data pad electrodes and the plurality of touch pad electrodes may have a first connection hole of the first wiring layer and the second wiring layer and a second connection hole of the second wiring layer and the third wiring layer, the first connection hole and the second connection hole being formed at different planar position.

In a display panel according to one embodiment of the present disclosure, the first connection hole and the second connection hole may overlap at least one insulating film.

A display panel according to one embodiment of the present disclosure, A display panel according to one embodiment of the present disclosure may further comprise a first insulating film between the first wiring layer and the second wiring layer and a second insulating film, a third insulating film, and a fourth insulating film between the second wiring layer and the third wiring layer. The first wiring layer may be located on the same layer as the plurality of gate lines, the second wiring layer may be located on the same layer as the plurality of data lines, and the third wiring layer may be located on the same layer as the plurality of pixel electrodes or the plurality of common electrodes.

In a display panel according to one embodiment of the present disclosure, the first connection hole may be provided in the first insulating film and overlaps at least a part of the second insulating film, and the second connection hole may be provided in the second insulating film and overlaps the first insulating film.

In a display panel according to one embodiment of the present disclosure, the plurality of touch lines may be located between the plurality of pixel electrodes and the plurality of common electrodes. Each of the plurality of touch pad electrodes may further comprise a fourth wiring layer extending from one of the plurality of the touch lines. And the fourth wiring layer may be located between the second wiring layer and the third wiring layer.

In a display panel according to one embodiment of the present disclosure, each of the plurality of touch pad electrodes may be connected to the second wiring layer thereunder and to the third wiring layer there above via a third connection hole in which the fourth wiring layer overlaps a part of the first connection hole.

In a display panel according to one embodiment of the present disclosure, the third connection hole may have a smaller size than the first connection hole, and the first wiring layer, the second wiring layer, the fourth wiring layer, and the third wiring layer may be sequentially stacked and electrically connected to each other in the third connection hole.

In a display panel according to one embodiment of the present disclosure, the first connection hole may be provided in a first insulating film between the first wiring layer and the second wiring layer, the second connection hole may be provided in second to fourth insulating films between the second wiring layer and the third wiring layer, the third connection hole may be provided in the second insulating film and the third insulating film, and the second insulating film may be provided in the first connection hole not overlapping the third connection hole.

In a display panel according to one embodiment of the present disclosure, the plurality of touch pad electrodes and the plurality of data pad electrodes may be alternately disposed in parallel, and a touch pad electrode and a data pad electrode adjacent to each other may have convex portions at different locations, the first connection hole and the second connection hole being provided in the convex portions.

In a display panel according to one embodiment of the present disclosure, the plurality of pixel electrodes and the plurality of common electrodes may be transparent.

A display panel according to one embodiment of the present disclosure may further comprise a drive chip or a flexible film having a plurality of lead electrodes connected to the plurality of data pad electrodes and the plurality of touch pad electrodes.

A display device according to one embodiment of the present disclosure may comprise a first substrate and a second substrate opposite each other, each of the first substrate and the second substrate having a display area and a non-display area surrounding the display area, a plurality of gate lines and a plurality of data lines provided in the display area on the substrate, the plurality of gate lines and the plurality of data lines intersecting each other to define a plurality of pixel areas, a plurality of pixel electrodes provided respectively in the plurality of pixel areas, a plurality of common electrodes overlapping the plurality of pixel electrodes, the plurality of common electrodes being located on a different layer than the plurality of pixel electrodes, a plurality of touch lines connected respectively to the plurality of common electrodes, a plurality of data pad electrodes provided in the non-display area, the plurality of data pad electrodes being electrically connected to the plurality of data lines, a plurality of touch pad electrodes provided in the non-display area, the plurality of touch pad electrodes being electrically connected to the plurality of touch lines and a liquid crystal layer provided between the first substrate and the second substrate.

Each of the plurality of data pad electrodes and the plurality of touch pad electrodes may comprise a first wiring layer to a third wiring layer overlapping each other, and each of the plurality of data pad electrodes and the plurality of touch pad electrodes may have a first connection hole of the first wiring layer and the second wiring layer and a second connection hole of the second wiring layer and the third wiring layer, the first connection hole and the second connection hole at different planar position.

In a display device according to one embodiment of the present disclosure, the first connection hole and the second connection hole may overlap at least one insulating film.

In a display device according to one embodiment of the present disclosure, the plurality of touch lines may be located between the pixel electrode and the common electrode, each of the plurality of touch pad electrodes may further comprise a fourth wiring layer extending from the touch line, and the fourth wiring layer may be located between the second wiring layer and the third wiring layer.

In a display device according to one embodiment of the present disclosure, each of the plurality of touch pad electrodes may be connected to the second wiring layer thereunder and to the third wiring layer there above via a third connection hole in which the fourth wiring layer overlaps a part of the first connection hole.

In a display device according to one embodiment of the present disclosure, the third connection hole may have a smaller size than the first connection hole, and the first wiring layer, the second wiring layer, the fourth wiring layer, and the third wiring layer may be sequentially stacked and electrically connected to each other in the third connection hole.

In a display device according to one embodiment of the present disclosure, the first connection hole may be provided in a first insulating film between the first wiring layer and the second wiring layer, the second connection hole may be provided in second to fourth insulating films between the second wiring layer and the third wiring layer, the third connection hole may be provided between the third insulating film and the fourth insulating film, and the second insulating film may be provided in the first connection hole not overlapping the third connection hole.

A display device according to one embodiment of the present disclosure may further comprise a first insulating film provided between the first wiring layer and the second wiring layer and a second insulating film, a third insulating film, and a fourth insulating film provided between the second wiring layer and the third wiring layer.

The first wiring layer may be located on the same layer as the plurality of gate lines, the second wiring layer may be located on the same layer as the plurality of data lines, and the third wiring layer may be located on the same layer as the pixel electrode or the common electrode.

In a display device according to one embodiment of the present disclosure, the first connection hole may be provided in the first insulating film and overlaps at least a part of the second insulating film, and the second connection hole may be provided in the second insulating film and overlaps the first insulating film.

As is apparent from the above description, in a display panel and a display device according to embodiments of the present disclosure, a pad electrode includes three or more wiring layers, wherein connection holes between two adjacent wiring layers are disposed at different planar positions, whereby it is possible to reduce the step between the connection holes.

In the display panel and the display device according to the embodiments of the present disclosure, four or more wiring layer connection portions are provided in a part of a touch pad electrode, wherein at least one connection hole overlaps another connection hole, and at least one insulating film is provided in the area other than the overlapping area of the connection holes, whereby it is possible to reduce the step from the periphery thereof.

In the display panel and the display device according to the embodiments of the present disclosure, it is possible to prevent an indentation defect, a bending defect, and a light leakage defect due to the step and to improve yield.

Those skilled in the art will understand that various modification and alternations are possible from the above description without departing from the technical idea of the present disclosure. Consequently, the technical scope of the present disclosure is defined not by the detailed description of the present disclosure.

What is claimed is:

1. A display panel comprising:
a substrate having a display area and a non-display area that surrounds the display area;
a plurality of gate lines and a plurality of data lines on the substrate, the plurality of gate lines and the plurality of data lines intersecting each other in the display area and define a plurality of pixel areas;
a plurality of pixel electrodes respectively disposed in the plurality of pixel areas;
a plurality of common electrodes overlapping the plurality of pixel electrodes, the plurality of common electrodes located on a different layer than the plurality of pixel electrodes;
a plurality of touch lines connected respectively to the plurality of common electrodes;
a plurality of data pad electrodes in the non-display area, the plurality of data pad electrodes being electrically connected to the plurality of data lines; and
a plurality of touch pad electrodes in the non-display area, the plurality of touch pad electrodes being electrically connected to the plurality of touch lines,
wherein each of the plurality of data pad electrodes and the plurality of touch pad electrodes comprises a first wiring layer, a second wiring layer, and a third wiring layer that overlap each other, and
wherein each of the plurality of data pad electrodes and the plurality of touch pad electrodes has a first connection hole that connects the first wiring layer and the second wiring layer and a second connection hole that connects the second wiring layer and the third wiring layer, and the first connection hole and the second connection hole are at different planar positions.

2. The display panel according to claim 1, wherein the first connection hole and the second connection hole overlap at least one insulating film.

3. The display panel according to claim 1, further comprising:
a first insulating film between the first wiring layer and the second wiring layer; and
a second insulating film, a third insulating film, and a fourth insulating film between the second wiring layer and the third wiring layer,
wherein the first wiring layer is on a same layer as the plurality of gate lines, the second wiring layer is on a same layer as the plurality of data lines, and the third wiring layer is on a same layer as the plurality of pixel electrodes or the plurality of common electrodes.

4. The display panel according to claim 3, wherein the first connection hole is in the first insulating film and overlaps at least a part of the second insulating film, and the second connection hole is in the second insulating film and overlaps the first insulating film.

5. The display panel according to claim 1, wherein the plurality of touch lines are between the plurality of pixel electrodes and the plurality of common electrodes,
wherein each of the plurality of touch pad electrodes further comprises a fourth wiring layer extending from one of the plurality of touch lines and the fourth wiring layer is between the second wiring layer and the third wiring layer.

6. The display panel according to claim 5, wherein each of the plurality of touch pad electrodes is connected to the second wiring layer under the plurality of touch pad electrodes and to the third wiring layer above the plurality of touch pad electrodes via a third connection hole in which the fourth wiring layer overlaps a part of the first connection hole.

7. The display panel according to claim 6, wherein the third connection hole has a smaller size than the first connection hole, and the first wiring layer, the second wiring layer, the fourth wiring layer, and the third wiring layer are sequentially stacked and electrically connected to each other in the third connection hole.

8. The display panel according to claim 6, wherein the first connection hole is in a first insulating film between the first wiring layer and the second wiring layer,
wherein the second connection hole is in a second insulating film, a third insulating film, and a fourth insulating film between the second wiring layer and the third wiring layer,
wherein the third connection hole is in the second insulating film and the third insulating film, and
wherein the second insulating film is in the first connection hole and is non-overlapping with the third connection hole.

9. The display panel according to claim 1, wherein the plurality of touch pad electrodes and the plurality of data pad electrodes are alternately disposed in parallel, and
wherein a touch pad electrode and a data pad electrode that are adjacent to each other have convex portions at different locations, the first connection hole and the second connection hole being in the convex portions.

10. The display panel according to claim 1, wherein the plurality of pixel electrodes and the plurality of common electrodes are transparent.

11. The display panel according to claim 1, further comprising:
a drive chip or a flexible film having a plurality of lead electrodes that are connected to the plurality of data pad electrodes and the plurality of touch pad electrodes.

12. A display device comprising:
a first substrate and a second substrate that are opposite each other, each of the first substrate and the second substrate having a display area and a non-display area that surrounds the display area;
a plurality of gate lines and a plurality of data lines in the display area on the first substrate, the plurality of gate lines and the plurality of data lines intersecting each other and define a plurality of pixel areas;
a plurality of pixel electrodes respectively disposed in the plurality of pixel areas;
a plurality of common electrodes overlapping the plurality of pixel electrodes, the plurality of common electrodes on a different layer than the plurality of pixel electrodes;
a plurality of touch lines connected respectively to the plurality of common electrodes;
a plurality of data pad electrodes in the non-display area, the plurality of data pad electrodes electrically connected to the plurality of data lines;
a plurality of touch pad electrodes in the non-display area, the plurality of touch pad electrodes electrically connected to the plurality of touch lines; and
a liquid crystal layer between the first substrate and the second substrate,
wherein each of the plurality of data pad electrodes and the plurality of touch pad electrodes comprises a first wiring layer, a second wiring layer and a third wiring layer overlapping each other, and
wherein each of the plurality of data pad electrodes and the plurality of touch pad electrodes has a first connection hole that connects the first wiring layer and the second wiring layer and a second connection hole that connects the second wiring layer and the third wiring layer, the first connection hole and the second connection hole at different planar positions.

13. The display device according to claim 12, wherein the first connection hole and the second connection hole overlap at least one insulating film.

14. The display device according to claim 12, wherein the plurality of touch lines are between a pixel electrode from the plurality of pixel electrodes and a common electrode from the plurality of common electrodes,
wherein each of the plurality of touch pad electrodes further comprises a fourth wiring layer extending from a touch line from the plurality of touch lines, and the fourth wiring layer is between the second wiring layer and the third wiring layer.

15. The display device according to claim 14, wherein each of the plurality of touch pad electrodes is connected to the second wiring layer under the plurality of touch pad electrodes and to the third wiring layer above the plurality of touch pad electrodes via a third connection hole in which the fourth wiring layer overlaps a part of the first connection hole.

16. The display device according to claim 15, wherein the third connection hole has a smaller size than the first connection hole, and the first wiring layer, the second wiring layer, the fourth wiring layer, and the third wiring layer are sequentially stacked and electrically connected to each other in the third connection hole.

17. The display device according to claim 16, wherein the first connection hole is in a first insulating film between the first wiring layer and the second wiring layer,
wherein the second connection hole is in a second insulating film, a third insulating film, and a fourth insulating film between the second wiring layer and the third wiring layer,
wherein the third connection hole is between the third insulating film and the fourth insulating film, and
wherein the second insulating film is in the first connection hole and is non-overlapping the third connection hole.

18. The display device according to claim 12, further comprising:
a first insulating film between the first wiring layer and the second wiring layer; and
a second insulating film, a third insulating film, and a fourth insulating film between the second wiring layer and the third wiring layer,
wherein the first wiring layer is on a same layer as the plurality of gate lines, the second wiring layer is on a same layer as the plurality of data lines, and the third wiring layer is on a same layer as a pixel electrode from the plurality of pixel electrodes or a common electrode from the plurality of common electrodes.

19. The display device according to claim 18, wherein the first connection hole is in the first insulating film and overlaps at least a part of the second insulating film, and the second connection hole is in the second insulating film and overlaps the first insulating film.
